(19) United States
(12) Patent Application Publication
(10) Pub. No.: US 2004/0111615 A1
(43) Pub. Date: Jun. 10, 2004

(54) Authentication method using symmetric authenticated key exchange and asymmetric authenticated key exchange

(76) Inventors: Dae Hun Nyang, Daejeon (KR); Byung Ho Chung, Daejeon (KR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/641,618

(22) Filed: Aug. 14, 2003

(30) Foreign Application Priority Data
Dec. 10, 2002 (KR) 2002-78486

(51) Int. Cl. H04L 9/00

(52) U.S. Cl. 713/168

(57) ABSTRACT

A user authentication method for authenticating a user on a communication network containing a user computer and an authentication server guarantees mathematical security in an offline dictionary attack, systematically converts a symmetric authenticated key exchange protocol into an asymmetric authenticated key exchange protocol, and causes little increase in the amount of calculation and traffic.

### BACKGROUND OF THE INVENTION

1. Field of the Invention

The present invention relates to a user authentication method, and more particularly to an authentication method for performing a user authentication process with an asymmetric authenticated key exchange protocol using a conventional symmetric authenticated key exchange protocol, and thus enhancing a user's security.

2. Description of the Related Art

Typically, a symmetric authenticated key exchange protocol has a private or password key of a user, thereby effectively performing an authentication and key exchange function. Provided that an authentication server is hacked, the private key of user is in danger from such hacking. To solve this problem, there has been proposed an asymmetric model scheme for allowing an authentication server to store only the result of applying a one-way function to the private key of user, and performing an authentication and key exchange operation. However, the asymmetric model scheme has many disadvantages in that it is difficult to design, has no mathematical security, and requires large numbers of calculations and much traffic, therefore it has not been widely used.

There have been developed many authentication and key exchange protocols, for example, a SRP proposed by Tom Wu, B-SPEKE proposed by David Jablon, and an EKE (Encrypted Key Exchange) proposed by Belloving, etc. However, such protocols do not yet mathematically guarantee their security. In recent times, although the security of the EKE has been only partially guaranteed and other protocols having a guaranteed mathematical security have been proposed, most of the EKE and the protocols depend on only an adhoc (arbeitsgemeinschaft deutsche historische Omnibusse und-clubs) design.

### SUMMARY OF THE INVENTION

Therefore, the present invention has been made in view of the above problems, and it is an object of the present invention to provide a user authentication method for guaranteeing mathematical security in an offline dictionary attack, systematically converting a symmetric authenticated key exchange protocol into an asymmetric authenticated key exchange protocol, and causing little increase in the amount of calculation and traffic.

In accordance with one aspect of the present invention, the above and other objects can be accomplished by the provision of a method for authenticating a user on a communication network containing a user computer and an authentication server, comprising the steps of: a) setting up a variety of system parameters needed to perform an authentication process; b) enabling a user to select an arbitrary random number (r) based on the setup system parameters, and transmitting to the authentication server a message composed of a test number A=Γ(r) being a result of applying a one-way function to a user ID and the random number (r); c) after performing the step (b), performing a symmetric authenticated key exchange operation between the user computer and the authentication server, authenticating the authentication server, and allowing both the authentication server and the user computer to share a temporary session key (tsk); d) after performing the step (c), enabling the authentication server to create a random number (t), and transmitting the random number (t) to the user computer; e) enabling the user computer to create a question number (c) using the random number (t) and the temporary session key (tsk), calculating a witness number B using the question number (c), and transmitting the witness number B to the authentication server; f) enabling the authentication server to verify the witness number B using the arbitrary session key (tsk), the test number A, and a KV (Key Verifier), etc; and g) if successful verification is performed in the step (f), enabling the authentication server and the user computer each to calculate a session key (sk).

In accordance with another aspect of the present invention, there is provided a computer-readable recording medium having a program in a computer, the program comprising the steps of: a) setting up a variety of system parameters needed to perform an authentication process; b) enabling a user to select an arbitrary random number (r) based on the setup system parameters, and transmitting to the authentication server a message composed of a test number A=Γ(r) being a result of applying a one-way function to a user ID and the random number (r); c) after performing the step (b), performing a symmetric authenticated key exchange operation between the user computer and the authentication server, authenticating the authentication server, and allowing both the authentication server and the user computer to share a temporary session key (tsk); d) after performing the step (c), enabling the authentication server to create a random number (t), and transmitting the random number (t) to the user computer; e) enabling the user computer to create a question number (c) using the random number (t) and the temporary session key (tsk), calculating a witness number B using the question number (c), and transmitting the witness number B to the authentication server; f) enabling the authentication server to verify the witness number B using the arbitrary session key (tsk), the test number A, and a KV (Key Verifier), etc; and g) if successful verification is performed in the step (f), enabling the authentication server and the user computer each to calculate a session key (sk).

### BRIEF DESCRIPTION OF THE DRAWINGS

The above and other objects, features and other advantages of the present invention will be more clearly understood from the following detailed description taken in conjunction with the accompanying drawing, in which:

FIG. 1 is a view illustrating an authentication process using symmetric and asymmetric authenticated key exchange protocols in accordance with a preferred embodiment of the present invention.

### DESCRIPTION OF THE PREFERRED EMBODIMENTS

Now, preferred embodiments of the present invention will be described in detail with reference to the annexed drawings. In the drawings, the same or similar elements are denoted by the same reference numerals even though they are depicted in different drawings. In the following description, a detailed description of known functions and configurations incorporated herein will be omitted when it may make the subject matter of the present invention rather unclear.

A symmetric authenticated key exchange protocol indicates a predetermined protocol which enables a server to perform user authentication using a shared private key (x) and shares a session key (tsk). The present invention is adapted for a user to authenticate a server, differently from a general use of the symmetric authenticated key exchange protocol. That is, the present invention determines whether a server has a KV (Key Verifier) using a KV parameter instead of a private key (x), and is adapted to create a session key (tsk). The KV indicates a result of applying a one-way function depending on Zero-Knowledge Proof protocol to a private or password key (pw) of a user. Therefore, the private key (pw) is prevented from being hacked even though an authentication server is hacked. The Zero-Knowledge Proof protocol is defined by a function Γ(r) for creating a test number in a random number, a function Λ(B,KV,c) for certifying validity of a witness number, and a function δ(c,r,pw) for creating the witness number. Provided that a Schnorr protocol is adapted as a Zero-Knowledge Proof protocol, system parameters of [G, Γ(r), δ(c,r,pw), Λ(B,KV,c)] become [Fp=<g>, g^{r}modp, r+pw*cmodq, g^{B}KV^{C}modp]. Provided that a Guillous-Quisquater protocol is adapted as a Zero-Knowledge Proof protocol, system parameters of [G, Γ(r), δ(c,r,pw), Λ(B,KV,c)] become [Zₙ^{*}, r^{e}modn, r*pw^{c}modn, B^{e}KV^{C}modn]. Herein, the system parameters of Pp, q, g and Fp can be recognized by referring to the Guillous-Quisquater protocol.

An authentication method according to the present invention sets up a variety of system parameters needed to perform an authentication process, enables a user to select an arbitrary random number (r) based on the setup system parameters, and transmits to the authentication server a message composed of a test number A=Γ(r) being a result of applying a one-way function (Γ) to a user ID (IDuser) and the random number (r). The user performs a symmetric authenticated key exchange protocol adapting a KV=Γ(pw) as a key. So, if the symmetric authenticated key exchange protocol is performed, then the user checks whether the authentication server knows a KV. If the symmetric authenticated key exchange protocol is successfully terminated, the authentication server shares a session key (tsk). If the symmetric authenticated key exchange protocol fails, the authentication server transmits an arbitrary random number (t) to the user. This random number is adapted along with the session key (tsk) to create a question number to be used for the Zero-Knowledge Proof protocol. The user calculates a question number c=H∥tsk (where, H( ) is a hash function having collision-freeness), calculates a witness number using the question number (c), and then transmits the witness number to the authentication server. The authentication server performs user authentication using a witness number, random number (t), a KV, and Λ, etc. If such user authentication is successfully performed, the session key (sk) is created using some part of a message exchanged with another session key (tsk).

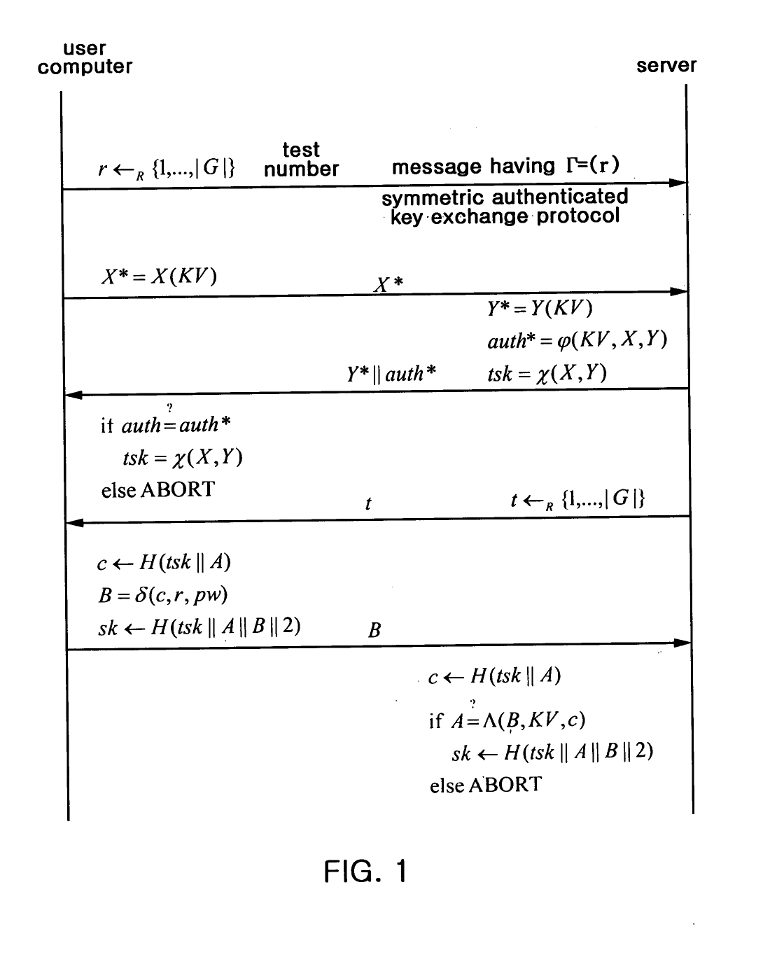

The authentication method according to the present invention will hereinafter be described with reference to FIG. 1. FIG. 1 is a view illustrating an authentication process using symmetric and asymmetric authenticated key exchange protocols in accordance with a preferred embodiment of the present invention.

Firstly, a system parameter is previously set up before a user and an authentication server perform a protocol. The system parameter is an engagement between the user and the authentication server, and is thereby shared with a plurality of users in a whole system. A reference character ‘G’ shown in FIG. 1 denotes a finite rotation group such as a multiplicative group Zₚ^{*} or an elliptical curve group, etc. A reference character ‘Γ( )’ denotes a one-way function. In accordance with the present invention, such one-way function ‘Γ( )’ is one of a one-way function based on a RSA (Rivest, Shamir, Adleman) problem, a one-way function based on discrete algebra, and a one-way function based on factorization into prime factors. A reference character ‘H( )’ denotes a hash function such as sha-1 or md5. A reference character ‘∥’ denotes a concatenation. Reference characters ‘ψ( )’ and ‘χ( )’ denote functions used for a symmetric authenticated key exchange protocol. In more detail, the function of ‘ψ( )’ is adapted to create a MAC (Message Authentication Code) and the function of ‘χ( )’ is adapted to create a session key ‘tsk’. Further, a reference character X(KV) denotes the result of applying a trapdoor one-way function to a randomly selected value of X through the use of a KV (Key Verifier), and a reference character Y(KV) denotes the result of applying a trapdoor one-way function to a randomly selected value of Y through the use of a KV (Key Verifier).

Referring to FIG. 1, private information of user is only a password (pw), and private information of an authentication server is a KV=Γ(pw) of each user.

A user computer of FIG. 1 transmits a message containing a user ID (IDᵤₛₑᵣ) and a test number ‘A=Γ(r)’ calculated by selecting an arbitrary random number ‘r’ to a server. As a result, an asymmetric protocol using a symmetric authenticated key exchange protocol begins.

After transmitting such message to the server, the user computer performs a well-known symmetric authenticated key exchange protocol. The symmetric authenticated key exchange protocol transmits a result X* of applying a trapdoor one-way function using a KV (Key Verifier) to an X value being randomly selected by the user computer to the server. The server attains a result Y* of applying a trapdoor one-way function using a KV to a randomly selected value of Y, and calculates an authentication key ‘auth*=ψ(KV,X,Y)’ and a session key ‘tsk=χ(X,Y)’. Then, the server transmits a value of Y*∥auth* to the user computer. The user computer compares a prescribed authentication value with the received authentication value, and authenticates the server when there is no difference between the authentication values such that the server and the user computer all share a session key ‘tsk’. But, in the case where the symmetric authenticated key exchange protocol fails to authenticate the server, the user computer recognizes that the server has no KV information such that it terminates a session.

In the case where the symmetric authenticated key exchange protocol is successfully terminated, the server creates a random number ‘t’ and then transmits it to the user computer. The user computer creates a question number c (i.e., c^{←}H(tsk∥A)) using the random number ‘t’ and a session key ‘tsk’, such that a witness number ‘B(=δ(c,r,pw))’ and a session key ‘sk(sk^{←}H(tsk∥A∥B∥2)’ are created. Then, the user computer transmits the witness number of B to the authentication server. As shown in A=Λ(B,KV,c), the authentication server verifies the received witness number of B using a key verifier ‘KV’ and a question number ‘c’. If such verification is successfully performed, the authentication server performs a user authentication, and calculates a session key. If such user authentication fails, the authentication server recognizes that the user does not know the password (pw) information, and then terminates a corresponding session.

As apparent from the above description, an authentication method according to the present invention guarantees a mathematical security in an offline dictionary attack. Also, a symmetric authenticated key exchange protocol can be easily converted to an asymmetric authenticated key exchange protocol. For example, a representative symmetric protocol being an EKE (Encrypted Key Exchange) proposed by Bellovin et al, can be easily converted to an asymmetric protocol. Also, the present invention is applicable to a user authenticated key exchange protocol widely used for a communication network. For example, the present invention is applicable to a key exchange and authentication protocol currently under discussion in an IEEE 802.11i group. Besides the aforesaid applications, a new authenticated key exchange protocol can be easily designed using the authentication method according to the present invention. As a result, although a user does not have an extensive knowledge of cryptography, he or she is able to easily design a securely-authenticated key exchange protocol.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method for authenticating a user on a communication network containing a user computer and an authentication server, comprising the steps of:
a) setting up a variety of system parameters needed to perform an authentication process;
b) enabling a user to select an arbitrary random number (r) based on the setup system parameters, and transmitting to the authentication server a message composed of a test number A=Γ(r) being a result of applying a one-way function to a user ID and the random number (r);
c) after performing the step (b), performing a symmetric authenticated key exchange operation between the user computer and the authentication server, authenticating the authentication server, and allowing both the authentication server and the user computer to share a temporary session key (tsk);
d) after performing the step (c), enabling the authentication server to create a random number (t), and transmitting the random number (t) to the user computer;
e) enabling the user computer to create a question number (c) using the random number (t) and the temporary session key (tsk), calculating a witness number B using the question number (c), and transmitting the witness number B to the authentication server;
f) enabling the authentication server to verify the witness number B using the arbitrary session key (tsk), the test number A, and a KV (Key Verifier), etc; and
g) if successful verification is performed in the step (f), enabling the authentication server and the user computer each to calculate a session key (sk).

2. The method as set forth in claim 1, wherein the system parameters in the step (a) include a function Γ(r) for creating a test number in a random number, a function Λ(B,KV,c) for certifying validity of a witness number, and a function δ(c,r,pw) for creating the witness number; in which
provided that a Schnorr protocol is adapted as a Zero-Knowledge Proof protocol, system parameters of [G, Γ(r), δ(c,r,pw), Λ(B,KV,c)] become [Fp=<g>, g^{r}modp, r+pw*cmodq, g^{B}KV^{C}modp]; and
provided that a Guillous-Quisquater protocol is adapted as a Zero-Knowledge Proof protocol, system parameters of [G, Γ(r), δ(c,r,pw), Λ(B,KV,c)] become [Zₙ^{*}, r^{e}modn, r*pw^{c}modn, B^{e}KV^{C}modn].

3. A computer-readable recording medium having a program in a computer, said program comprising the steps of:
a) setting up a variety of system parameters needed to perform an authentication process;
b) enabling a user to select an arbitrary random number (r) based on the setup system parameters, and transmitting to the authentication server a message composed of a test number A=Γ(r) being a result of applying a one-way function to a user ID and the random number (r);
c) after performing the step (b), performing a symmetric authenticated key exchange operation between the user computer and the authentication server, authenticating the authentication server, and allowing both the authentication server and the user computer to share a temporary session key (tsk);
d) after performing the step (c), enabling the authentication server to create a random number (t), and transmitting the random number (t) to the user computer;
e) enabling the user computer to create a question number (c) using the random number (t) and the temporary session key (tsk), calculating a witness number B using the question number (c), and transmitting the witness number B to the authentication server;
f) enabling the authentication server to verify the witness number B using the arbitrary session key (tsk), the test number A, and a KV (Key Verifier), etc; and
g) if successful verification is performed in the step (f), enabling the authentication server and the user computer each to calculate a session key (sk).
